(19) United States
(12) Patent Application Publication
(10) Pub. No.: US 2008/0128281 A1
(43) Pub. Date: Jun. 5, 2008

(54) Gel Composite

(75) Inventors: Ingrid Blikstad, Uppsala (SE); Anders Larsson, Uppsala (SE); Ronnie Palmgren, Uppsala (SE); Sofia Hiort af Ornas (Soderberg), Stockholm (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 11/719,987

(22) PCT Filed: Nov. 23, 2005
(86) PCT No.: PCT/SE05/01756

§ 371 Date: Jun. 14, 2007

(30) Foreign Application Priority Data
Nov. 26, 2004 (SE) 0402908-8
May 3, 2005 (SE) 0501025-1

(51) Int. Cl. B01D 57/02

(52) U.S. Cl. 204/469; 204/610; 204/456

(57) ABSTRACT

The present invention relates to electrophoresis and in particular electrophoretic gel composites used for separation of biomolecules, such as proteins and peptides. More particularly, the invention relates to gel composites with improved oxygen barrier properties. The invention provides an electrophoretic gel composite, comprising a) a polymer support; b) an electrophoretic hydrogel; and c) an oxygen barrier film between the polymer support and the hydrogel. Preferably the hydrogel is produced in the presence of an oxygen scavenger and/or under inert atmosphere. The improved oxygen barrier properties make the gel composites excellent for electrophoresis without artifacts in the gel.

### FIELD OF THE INVENTION

The present invention relates to electrophoresis and in particular electrophoretic gel composites used for separation of biomolecules, such as proteins and peptides. More particularly, the invention relates to gel composites with improved oxygen barrier properties.

### BACKGROUND

Electrophoresis has been used for a long time to separate charged molecules according to their difference in migration rate under the influence of an electrical field.

Traditionally, the molecules are stained in the gel after electrophoresis by more or less selective dye stains or by staining using colloidal metal particles.

The molecules to be separated may also be labelled for example with a radioactive or fluorescence label, for detection after the electrophoresis.

Today it is most common to avoid the use of radioactivity in favour of fluorescence labelling.

However, the electrophoretic backings used to carry the electrophoretic slab gel are in many cases fluorescent per se which disturbs the detection procedure. This disturbance occurs when samples are fluorescence labelled before or after the electrophoresis.

Commonly used electrophoretic support films, such as polyethylene terephtalate (PET) function satisfactorily for relatively large amounts of fluorescence labelled biomolecules but disturb and hinder the detection of low amounts of biomolecules after slab gel electrophoresis.

Since this limits the applicability of the technique in for example diagnostic assays it is very important to be able to detect very low amounts of biomolecules in for example a biological sample. Another case is in pharmacological research where most of the pharmacologically interesting proteins occur at very low concentrations compared to high abundance proteins, such as albumin. One way to solve the problem with background fluorescence has been to use glass as a gel support. However, of weight, safety and environmental reasons glass is in many cases not desirable.

In SE 03 01592-2 low fluorescent (LF) polymers are described useful as supports for production of pre-swollen ready to use gels for fluorescence detection. To provide oxygen barrier and gel adherent properties to the LF polymer a layer of allylglycidylagarose or a combined layer of glass and silane, is provided between the LF-polymer and the hydrogel.

Hydrogels cast on any supports, in which the hydrogel is adhered to its support are referred to as backed hydrogels. A disadvantage with backed hydrogels cast on polymers is that streaking of the samples occur in the gel close to the polymer support during electrophoresis.

In glass backed gels this streaking does not occur. However, for many applications it would be more desirable to work with polymer support films than with glass.

### SUMMARY OF THE INVENTION

The present inventors have found that it is necessary to improve the oxygen barrier properties between polymers supports and hydrogels. If the oxygen barrier is insufficient, then the hydrogel will polymerise inadequately in the layer next to the polymer support and streaking of sample proteins will occur in this layer. The streaking phenomenon has been observed in gels adhered to conventional polymer supports such as PET supports, but is especially a problem with LF polymer supports.

The present invention provides a gel composite having very good oxygen barrier properties so that the polymerisation of the hydrogel will not be inhibited. Thereby the streaking of the samples is substantially eliminated.

Moreover, the present invention provides a low fluorescent electrophoretic gel composite giving negligible background fluorescence for most analyses. This gel composite enables detection of very low sample amounts after electrophoresis. The samples may be fluorescence labelled before or after electrophoresis.

In a first aspect the present invention relates to a electrophoretic gel composite, comprising
a) a polymer support;
b) an electrophoretic hydrogel; and
c) an oxygen barrier film between the polymer support and the hydrogel.
The polymer support may be made of any polymer, both low fluorescent and fluorescent, and may for example be a PET polymer or a LF polymer.

The polymer support is coated or laminated with an oxygen barrier layer, which gives the resulting laminate very low oxygen permeability. This eliminates inhibition of the gel, for example polyacrylamide, polymerisation due to oxygen diffusion from the film into the monomer solution

The oxygen barrier film, is preferably a polymer or copolymer of vinyl alcohol and may be selected from poly(vinyl chloride), poly(vinylidene dichloride), poly(vinylidene fluoride), poly(ethylene terephtalate), polymers and copolymers from acrylonitrile, aromatic polyamides, polyethylene naphtalenate, poly(vinyl alcohol) and preferably ethylene-vinyl-alcohol copolymers. Alternatively, the oxygen barrier film is made of a thin glass layer.

These barrier films should be laminated or coated on the polymer supports in very thin layers, such as 1-50 μm, preferably 10-20 μm.

The oxygen barrier properties of the above barrier films depends on the types of substituent groups present in a polymer which influence two main factors: how tightly the polymer chains are bound together and how much free volume exists between the chains. Cohesive energy density is a measure of the polarity of a polymer and the energy binding the polymer chains together. In general, the higher a polymer cohesive energy density, the more difficult it is for the polymer chains to open and allow a permeant to pass. According to the invention the cohesive energy density is over 85 Cal/cm³.

Free volume is a measure of the degree of interstitial space between molecules in a polymer. The permeability coefficient decrease with a decrease in free volume. According to the invention the free fractional volume of the barrier film is below 0.150. (Free fractional volume is the ratio of the interstitial space between molecules to the volume of the polymer at a temperature of absolute zero).

In principle, any thin polymer film could be used for this purpose as long as the oxygen barrier properties are sufficient. The thickness of the oxygen barrier film is chosen in such a way that the oxygen barrier properties are sufficient while the fluorescence contribution is negligible for fluorescence detection. For other detection, only the oxygen barrier properties are important.

The hydrogel may be agarose, acrylamide, derivatized acrylamide or polyacrylamide co-polymerised with allylglycidyl agaraose (AGA).

To further increase the oxygen barrier properties, a composite according to the invention is produced in the presence of an oxygen scavenger in the hydrogel. Preferably, the hydrogel is polymerized in presence of the oxygen scavenger.

The oxygen scavenger may be selected from the group consisting of sodium sulfite, sodium bisulfite, sodium thiosulfate, sodium lignosulfate, ammonium bisulfite, hydroquinone, diethylhydroxyethanol, diethylhydroxylamine, methylethylketoxime, ascorbic acid, erythorbic acid, and sodium erythorbate.

In one embodiment, an inert gas, such as argon or nitrogen, is added before or during polymerisation of the gel. For example, the support polymer, and/or polymer film on the support polymer, may be treated with argon or nitrogen just before the gel is polymerised thereon or the composite may be stored in this atmosphere. Additionally or alternatively, the polymerisation may be performed under argon or nitrogen atmosphere or argon or nitrogen may be bubbled through the polymerisation mix during polymerisation. Preferably the polymerisation mix is degassed.

Preferably, a gel adherent layer is positioned between the polymer film and the hydrogel and preferably, the gel adherent layer is made of allylglycidyl agarose (AGA). AGA improves the oxygen barrier properties of the oxygen barrier layer and also gives excellent gel adherent properties. Alternatively, in the case of glass as an oxygen barrier film, the gel adherent layer is made of silane.

In this case, the thin barrier film is coated or laminated on the LF-polymer and AGA is coated on the barrier film. For AGA coating the thin barrier film needs to be hydrophilic or treated with a hydrophilisation method such as plasma or corona. A hydrogel (e.g. a polyacrylamide gel) is polymerised onto the AGA surface with good adhesion, chemically bonded to the AGA layer.

In one embodiment of the invention, the gel composite comprises a polymer support of a low fluorescent (LF) polymer having the following formula:

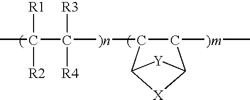

wherein
n=0-100 000
m=0-100 000
R1, R2, R3 and R4=H, F, Cl, Br, I, methyl groups or non-aromatic hydrocarbon chains (optionally containing branches or cyclic structures) such as ethyl, ethenyl, propyl, isopropyl, propenyl, butyl, branched butyl, butenyl, cyclobutyl, pentyl, branched pentyl, pentenyl, cyclopentyl, hexyl, branched hexyl, cyclohexyl;

### X, Y=methylene groups or non-aromatic hydrocarbon chains (optionally containing branches or cyclic structures) such as ethylene, ethenylene, propylene, isopropylene, propenylene, butylene, branched butylene, butenylene;

### Y can optionally be absent.

Preferably, the LF polymer is

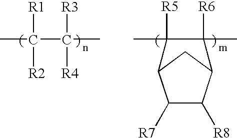

wherein
n=0, R5=R6=H
or most preferably

### R1=R2=R3=R4=R5=R6=H, R7, R8=H or CH₃

According to the invention, the LF polymer is transparent and has a haze value lower than 3%. The LF-polymer has a suitable flexibility, i.e. a flexural modulus of 1300-2500 MPa.

For low fluorescence and easy handling, the LF polymer is preferably ≧100 μm thick.

In a preferred gel composite, the LF support polymer is a polycycloolefin, the oxygen barrier is a thin layer of a barrier polymer film laminated or coated to the LF-polymer; and the hydrogel is polyacrylamide. As stated above, a layer of AGA is preferably included between the barrier film and the hydrogel. The hydrogel preferably is produced in the presence of an oxygen scavenger.

In most preferred embodiment the gel composite comprises four layers. First a support polymer according to the most preferred polycycloolefin which is 100-200 μm thick, then an oxygen barrier film which is 10-20 μm thick, then a gel adherent coating is 30-70 μm thick, and last a hydrogel comprising polyacrylamide which is 0.3-1.5 mm thick. The hydrogel preferably is produced in the presence of 1.25 mM sodium sulfite or other oxygen scavenger in other concentration.

In a preferred embodiment, the composite comprises a support polymer of the preferred polycycloolefin, the oxygen barrier film is ethylene-vinyl-alcohol, the gel adherent layer is AGA, and the hydrogel is polyacrylamide.

In another preferred embodiment, the composite comprises a support polymer of the preferred polycycloolefin, the oxygen barrier film is a glass layer, the gel adherent layer is silane, and the hydrogel is polyacrylamide, optionally co-polymerised with AGA.

In a second aspect, the invention relates to a kit for 2D electrophoresis comprising a composite as described above for the second dimension, and a IEF (isoelectric focusing) strip, such as Immobilibe Dry Strip™, for the first dimension. For running of the second dimension, the Immobiline Dry strip is sealed to the gel composite by an appropriate sealant. The samples in the gel composite may be labelled before or after electrophoresis.

Preferably, the hydrogel is pre-cast on the composite. In this case the composite is ready to use. In this case the kit may further comprise a buffer, such as N-piperidino (or N-pyrrolidino) propionamide (PPA) buffer which keeps the gel composite storage stable in its swollen state.

In a third aspect, the invention relates to use of the above composite or kit in electrophoresis. The gel composite may be used in 1D as well as 2D electrophoresis.

The gel composite may be used to analyse different patient sample(s) or for comparison of patient and healthy samples for diagnosis of different conditions, such as different disease conditions.

The gel composite may also be used for finding pharmacologically interesting substances. For example, low abundant proteins in patient samples may be interesting as pharmacological or diagnostic target molecules.

The invention is an improvement and provides less streaking in relation to conventional PET gels, such as DALT™, gels.

In a preferred embodiment, the gel composite according to the invention is low fluorescent and is used for electrophoretic separation of fluorescence labelled, such as with Cy™-dyes, biomolecules (particularly proteins, peptides and nucleotides) with subsequent fluorescence detection. The samples may also be labelled after electrophoresis with specific dyes.

### DETAILED DESCRIPTION OF THE INVENTION

The following experimental section is only intended to exemplify the invention and is not to be construed as limiting for the invention.

### Experimental Part

### 1. Synthesis of Barrier/Gel Adherent Material (Allylglycidylagarose, AGA):

Agarose (10 grams) is dissolved in 490 ml of boiling water. The solution is maintained at 80° C. 1.67 g sodium borohydride was added to 10 ml of 14 M sodium hydroxide and then added to the agarose solution under constant stirring. After ten minutes, 100 ml of a 10% sodium hydroxide solution is added, followed by drop-wise addition of 25 ml of allylglycidyl ether over a 15-minute period. After one hour, an additional 25 ml of allylglycidyl ether is added as before and reacted for another hour. The reaction mixture is cooled to 60° C. and then neutralized by the addition of 4 M acetic acid.

The solution is slowly added to three volumes of acetone while stirring, yielding a white precipitate. The solvent was decanted and the precipitate was dissolved in water and the solution was again precipitated in acetone. This procedure was repeated five times and the final precipitate was recovered by filtering through filter paper. The product was oven dried at 60° C. and ground to a powder.

### 2. Coating a Barrier/Gel Adherent Layer on Plastic Film:

The coating was made on biaxially oriented polypropylene (OPP C58, UCB Films) (both with and without glass coating), PET, Aclar 11C (Honeywell) and Zeonor 1420R (Zeon Chemicals). Before AGA coating the films were laminated with oxygen barrier films of 10-20 μm thick ethylene vinyl alcohol copolymer.

Sheets of the plastics mentioned above were plasma treated in a Plasma Electronic PICCOLO RF-powered reactor under the following conditions: RF power 240 Watts, Oxygen flow 180 sccm, for three minutes. Subsequent to the plasma treatment the laminated film was coated with a 1-% aqueous solution of allylglycidylagarose. The coating was prepared to a wet thickness of 36 μm using a spiral-wound rod applicator.

Keeping the laminated film with allyl glycidyl coating in an oven of temperature 100° C. for 20 minutes evaporates the water. After the heat treatment of the coating it is put in a freezer to force a gelation of the allylglycidylagarose coating.

### 3. Casting of a Polyacrylamide Gel

The casting apparatus consists of glass plates (8.5×8.5 cm). The coated plastic laminate was placed on top of the glass plate with the hydrophilic side containing the allylglycidyl-agarose film facing outwards. A U-shaped 1-mm thick spacer was placed between the glass supported allylglycidylagarose coated plastic and another glass plate. This cassette was held in place by four clamps, and placed in a vertical position.

Optionally the cassette is incubated in argon atmosphere for at least 4 hours depending on the type and thickness of the film.

Solutions of ammonium persulfate (APS) and tetramethyl ethylenediamine (Temed) were prepared prior to use by dissolving 1.0 g APS in 100 ml distilled water and 750 μl of Temed in 100 ml distilled water. Just prior to casting 90 ml of acrylamide solution were mixed with 5 ml each of the APS and Temed solutions. Optionally, an oxygen scavenger (sodium bisulfite) was added to the polymerisation mixture in a concentration of 1.25 mM.

The casting solution was injected to the vertical casting cassette from the top via a syringe. On top of the casting solution were a few drops of isopropanol added to prevent oxygen inhibition of the polymerization.

### 4. Polyacrylamide Gel Electrophoresis

The gel composites according to the invention are especially suited for the second dimension of 2D electrophoresis. In this example, the first dimension, i.e. isoelectric focusing, is run on Immobiline Dry Strips™ under conventional conditions.

For the second dimension, the strips were equilibrated with dithiotreitol (DTT), applied on top of the gel, and sealed with sealing solution. Proteins were allowed to enter the gel with constant power (2.5 W/gel) for 15-30 minutes and the separation was then run with 17 W/gel (max 200 W) until the dye front reached the bottom of the gel. Buffers, temperature etc. was according to conventional methods.

In gels according to the invention, 50 μl Cy5™ labelled mouse liver protein was used and the gels were scanned in a Typhoon 9400 at 200 microns resolution, pmt 500 V at Cy5 wavelengths and normal sensitivity.

In a comparative example with conventional GelBond™ gels, 200 μl of the same sample had to be used for detection purposes.

The results showed that the composite gels according to the invention show better electrophoresis maps with improved oxygen barrier properties and thus less streaking than the conventional gels.

1. An electrophoretic gel composite, comprising
a) a polymer support;
b) an electrophoretic hydrogel; and
c) an oxygen barrier film between the polymer support and the hydrogel.

2. The composite of claim 1, wherein the oxygen barrier film is a polymer selected from as poly(vinyl chloride), poly(vinylidene dichloride), poly(vinylidene fluoride), poly(ethylene terephtalate), polymers and copolymers from acrylonitrile, aromatic polyamides, polyethylene naphtalenate, poly(vinyl alcohol) and ethylene-vinyl-alcohol copolymers.

3. The composite of claim 1, wherein the oxygen barrier film is a glass layer.

4. The composite of claim 1, wherein the hydrogel is agarose, polyacrylamide, derivatized polyacrylamide or polyacrylamide co-polymerized with allylglycidyl agaraose.

5. The composite of claim 1, wherein the hydrogel is produced in the presence of an oxygen scavenger.

6. The composite of claim 5, wherein the oxygen scavenger is selected from the group consisting of sodium sulfite, sodium bisulfite, sodium thiosulfate, sodium lignosulfate, ammonium bisulfite, hydroquinone, diethylhydroxyethanol, diethylhydroxylamine, methylethylketoxime, ascorbic acid, erythorbic acid, and sodium erythorbate.

7. The gel composite of claim 1, further comprising a gel adherent layer between the polymer film and the hydrogel.

8. The gel composite of claim 3, further comprising a gel adherent layer between the polymer film and the hydro, gel and wherein the gel adherent layer is made of allylglycidyl agarose or silane.

9. The composite of claim 1, wherein the composite is produced in the presence of inert gas.

10. The gel composite of claim 1, wherein the polymer support is a low fluorescent (LF) polymer having the following formula: 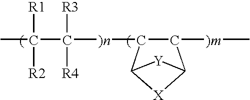
wherein
n=0-100000
m=0-100000
R1, R2, R3 and R4=H, F, Cl, Br, I, methyl groups or non-aromatic hydrocarbon chains (optionally containing branches or cyclic structures) such as ethyl, ethenyl, propyl, isopropyl, propenyl, butyl, branched butyl, butenyl, cyclobutyl, pentyl, branched pentyl, pentenyl, cyclopentyl, hexyl, branched hexyl, cyclohexyl;
X, Y=methylene groups or non-aromatic hydrocarbon chains (optionally containing branches or cyclic structures) such as ethylene, ethenylene, propylene, isopropylene, propenylene, butylene, branched butylene, butenylene;
Y can optionally be absent.

11. The composite of claim 10, wherein the LF polymer is 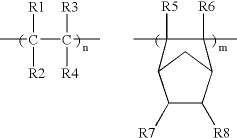
wherein
n=0, R5=R6=H or
R1=R=R3=R4=R5=R6=H, R7, R8=H or CH₃

12. The composite of claim 11, comprising a LF polymer support which is a polycycloolefin wherein R1=R2 R3=R4=R5=R6=H, R7, R8=H or CH₃.

13. The composite of claim 7, wherein the support polycycloolefin polymer is the oxygen barrier film is ethylene-vinyl-alcohol, the gel adherent layer is an AGA, and the hydrogel is polyacrylamide.

14. The composite of claim 8, wherein the support polycycloolefin polymer is the oxygen barrier film is a glass layer, the gel adherent layer is silane, and the hydrogel is polyacrylamide optionally co-polymerised with AGA.

15. A kit for 2D electrophoresis comprising a the composite of claim 1 for the second dimension, and an IEF (isoelectric focussing) strip for the first dimension.

16. The kit of claim 15, wherein the hydrogel is pre-cast on the composite.

17. In a method for electrophoresis separation of different samples, the improvement comprises using the gel composite of claim 1 for said electrophoresis separation.

18. The method of claim 17, wherein the samples comprise patient sample(s) for diagnosis of different conditions.

19. The method of claim 17, for detecting drug target and diagnostic target molecules.
